(19) United States
(12) Patent Application Publication
(10) Pub. No.: US 2004/0052219 A1
(43) Pub. Date: Mar. 18, 2004

(54) Gate controller for controlling digital asynchronized half-duplex serial transmission between multi-interfaces and method for controlling the same

(75) Inventors: Tse-Ming Lin, Taipei (TW); Chih Ming Tsai, Taipei (TW); Chien-Hsing Liu, Shinjuang City (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP ELECTRONICS INC.

(21) Appl. No.: 10/354,543

(22) Filed: Jan. 29, 2003

(30) Foreign Application Priority Data
Sep. 18, 2002 (TW) 91121367

(51) Int. Cl. H04B 7/005; H04L 12/66

(52) U.S. Cl. 370/278; 370/463

(57) ABSTRACT

A controller for digital asynchronized half-duplex serial transmission gate. The controller includes a RS232/TTL interface for transforming a received RS232 signal into a TTL signal, a RS484/TTL interface for transforming the TTL signal into a RS485 signal, having a Rx/Tx control terminal, and a phase processing unit for receiving the TTL signal to generate a Rx/Tx control signal input to the Rx/Tx control terminal, wherein the Rx/Tx control signal is derived by inverting and delaying the TTL signal for a time interval.

### BACKGROUND OF THE INVENTION

1. Field of the Invention

The present invention relates to a gate controller and control method for digital asynchronized half-duplex serial transmission and particularly to a gate controller and controlling method applicable to digital asynchronized half-duplex serial transmission between a host and a plurality of devices with different baud rates.

2. Description of the Related Art

RS232 is a digital asynchronized half-duplex serial transmission standard, wherein each byte comprises one start bit, 7 or 8 data bits, one or zero even (or odd) parity bits, and 1, 1.5 or 2 stop bits. Accordingly, the length of each serial signal transmitted in the standard of RS232 could vary from 9 (1 start bit, 7 data bits, 0 parity bit and 1 stop bit) to 12 (1 start bit, 8 data bits, 1 parity bit and 2 stop bit) bits. At present, the bit lengths for RS232 products from different manufacturers have not been standardized and thus not the same. Additionally, the baud rate (bits transmitted per second) of each RS232 product such as an industrial appliance can also be different from each other since there is not a specified/a uniform standard. For the communication between devices through RS232, all the devices must be from the same manufacturer and have the same baud rates; or the communication will fail.

In a half-duplex transmission system, each of the devices can only transmit and receive data alternately rather than simultaneously. It operates in the manner of “Q&A” model. While transmitting data to a slave unit, a host waits for a response of the slave unit and cannot receive any other data.

Due to the requirements of the full-automatic manufacture, most equipments or instruments are controlled by a PLC (Programmable Logic Controller). These controllers typically have RS232 interfaces and can be connected together by way of a network in which each PLC has its own IP address.

FIG. 1 is a diagram showing a conventional RS232 network of PLC-enabled units. Through switching a multi-port RS232 interface card, the host (shown as PC) communicates with only one of the multiple PLC-enabled units. When the multi-port RS232 interface card is sequentially switched to each of the PLC-enabled units, the host can communicate with each of the multiple PLC-enabled units respectively. However, since the PLC-enabled units are usually distributed throughout the factory, many RS232 cables interconnecting among the units must be deployed in the active factory environment, and such a complicated layout is susceptible to damage. Such a network configuration will cause high costs and difficulties in maintenance.

FIG. 2 is a diagram showing a conventional RS232/RS485 network of PLC-enabled units. The host is connected to the PLC-enabled units PLC1, PLCn and PLCm through four common RS485 cables and converters C1, C2, C3 and C4. This will increase the cable costs. The host sends commands simultaneously to PLC1, PLCn and PLCm, although only the designated command recipient responds to the host. For example, when the host sends a command addressed to PLC1, all the units PLC1, PLCn and PLCm receive the command but only PLC1 responds.

FIG. 3 is a diagram showing another conventional RS232/RS485 network of PLC-enabled units. The host is connected to the PLC-enabled units PLC1, PLCn and PLCm through two common RS485 cables and a converter C1. This connection reduces the cable cost to half compared with that of the system in FIG. 2. The operation of the network in FIG. 3 is similar to that in FIG. 2 except that lines TX+, TX−, RX+ and RX− in FIG. 2 and lines A1, B1, A2 and B2 in FIG. 3 transfer data in different directions. In FIG. 2, lines TX+ and TX− are dedicated for transmissions from the host to PLC-enabled units, and lines RX+ and RX− are dedicated for responding from the PLC-enabled units to the host. However, in FIG. 3, the data can be transferred in both directions through lines A1, B1, A2 and B2. This configuration is more complicated than that in FIG. 2. Moreover, as previously described, it is essential for the network configurations in FIGS. 2 and 3 that all of units PLC1, PLCn and PLCm have the same baud rate and byte length. Otherwise, or the network will fail.

However, in practice, all the PLC-enabled units are rarely installed at the same time, being typically brought into the factory in different phases. It is thus difficult to ensure that all PLC-enabled units are from the same manufacturer and have the same baud rate. Thus, conventional network configurations are not applicable to such a situation.

### SUMMARY OF THE INVENTION

The object of the present invention is to provide a controller and control method for a digital asynchronized half-duplex serial transmission gate, applicable to transmission between devices with different baud rates.

The present invention provides a controller for digital asynchronized half-duplex serial transmission gate, comprising a RS232/TTL interface for transformation of a received RS232 signal into a TTL signal, a RS485/TTL interface for transformation of the TTL signal into a RS485 signal, having a Rx/Tx control terminal and a phase processing unit for receiving the TTL signal to generate a Rx/Tx control signal input to the Rx/Tx control terminal, wherein the Rx/Tx control signal is derived by inverting and delaying the TTL signal for a time interval.

The present invention provides another controller for digital asynchronized half-duplex serial transmission gate, comprising a first RS485/TTL interface for transformation between a first TTL signal and a first RS485 signal, having a first Rx/Tx control terminal, a second RS485/TTL interface for transformation between a second TTL signal and a second RS485 signal, having a second Rx/Tx control terminal, a first phase processing unit for receiving the first TTL signal to generate a first Rx/Tx control signal input to the first Rx/Tx control terminal, wherein the first Rx/Tx control signal is derived by inverting and delaying the first TTL signal for a first clock, and a second phase processing unit for receiving the second TTL signal to generate a second Rx/Tx control signal input to the second Rx/Tx control terminal, wherein the second Rx/Tx control signal is derived by inverting and delaying the second TTL signal for a second time interval.

The present invention further provides a method for control of a digital asynchronized half-duplex serial transmission gate coupled between a RS232/TTL interface and a RS485/TTL interface having a Rx/Tx control terminal, the method comprises the steps of both receipt and transformation of a RS232 signal into a TTL signal by the RS232/TTL interface, inverting and delaying the TTL signal for a time interval to generate a Rx/Tx control signal, sending the Rx/Tx control signal to the Rx/Tx control terminal, and both receipt and transformation of the TTL signal into a RS485 signal by the RS485/TTL interface according to the Rx/Tx control signal input to the Rx/Tx control terminal.

The present invention also provides another method for control of a digital asynchronized half-duplex serial transmission gate coupled between a first and second RS485/TTL interface having a second and first Rx/Tx control terminal respectively, the method comprises implementation of transformation between a first RS485 signal and a first TTL signal by the first RS485/TTL interface, inverting and delaying the first TTL signal for a first time interval to generate a first Rx/Tx control signal, sending the first Rx/Tx control signal to the first Rx/Tx control terminal, receipt and transformation of the first TTL signal into a second RS485 signal by the second RS485/TTL interface according to the first Rx/Tx control signal input to the first Rx/Tx control terminal, implementation of transformation between a second RS485 signal and a second TTL signal by the second RS485/TTL interface, inverting and delaying the second TTL signal for a second period if time to generate a second Rx/Tx control signal, sending the second Rx/Tx control signal to the second Rx/Tx control terminal, and receipt and transformation of second TTL signal into the first RS485 signal by the second RS485/TTL interface according to the second Rx/Tx control signal input to the second Rx/Tx control terminal.

### BRIEF DESCRIPTION OF THE DRAWINGS

The preferred embodiment of the invention is hereinafter described with reference to the accompanying drawings in which:

FIG. 1 is a diagram showing a conventional RS232 network of PLC-enabled units.

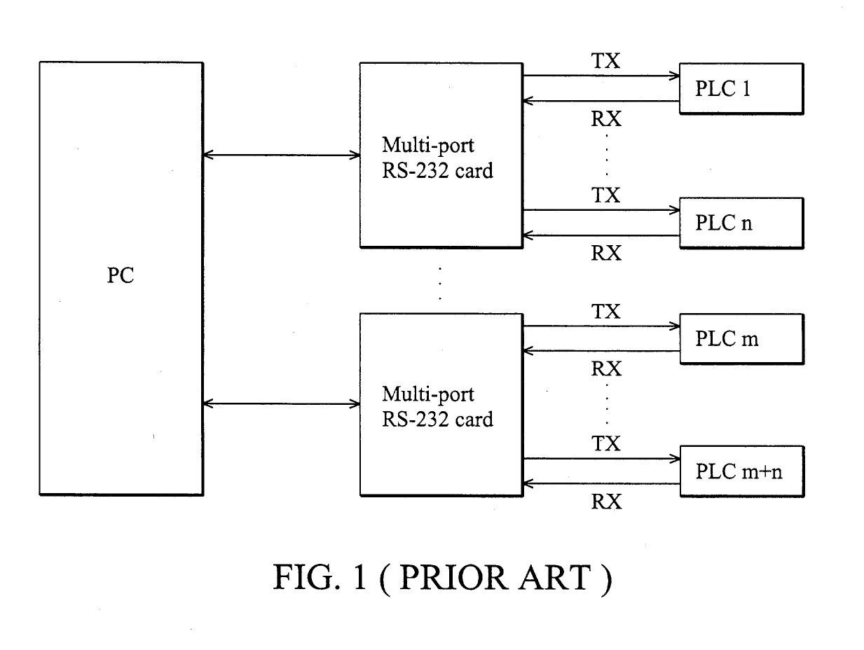

FIG. 2 is a diagram showing a conventional RS232/RS485 network of PLC-enabled units.

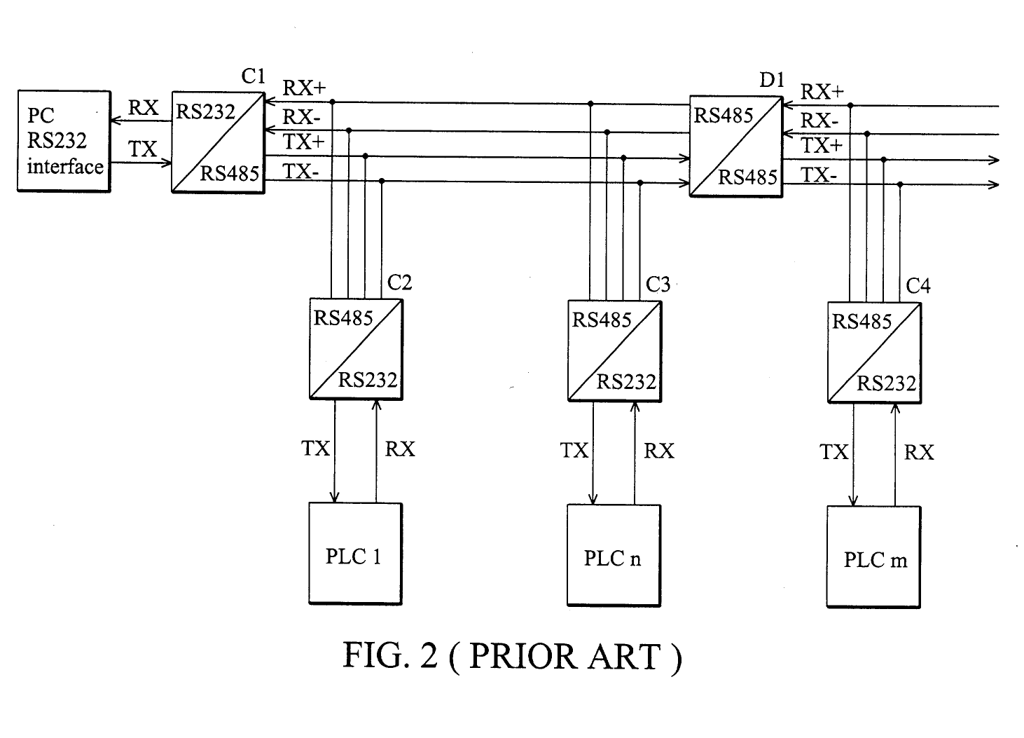

FIG. 3 is a diagram showing another conventional RS232/RS485 network of PLC-enabled units.

FIG. 4 is a diagram showing an equivalent circuit of a RS485 interface circuit.

FIG. 5a is a diagram showing a conventional RS232/RS485 network of PLC-enabled units.

FIG. 5b is a diagram showing time sequence of the signals according to the network shown in FIG. 5a.

FIG. 6a is a diagram showing a gate controller according to one embodiment of the invention.

FIG. 6b is a diagram showing time sequence of the signals according to the gate controller shown in FIG. 6a.

FIG. 7a is a diagram showing a gate controller according to another embodiment of the invention.

FIG. 7b is a diagram showing time sequence of the signals according to the gate controller shown in FIG. 7a.

### DETAILED DESCRIPTION OF THE INVENTION

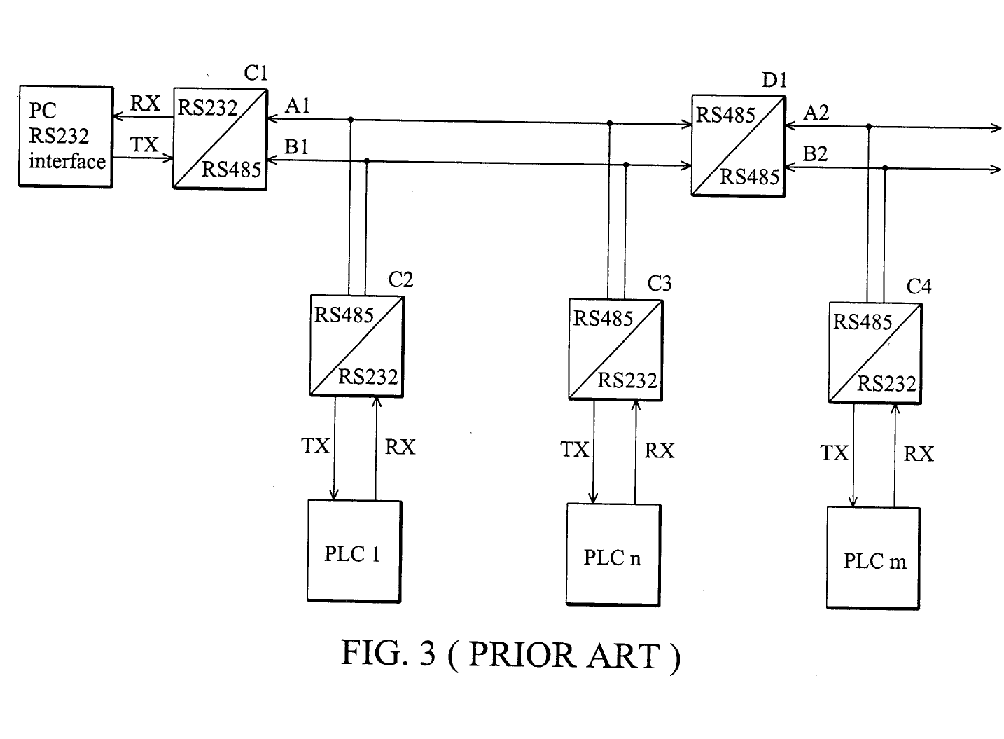

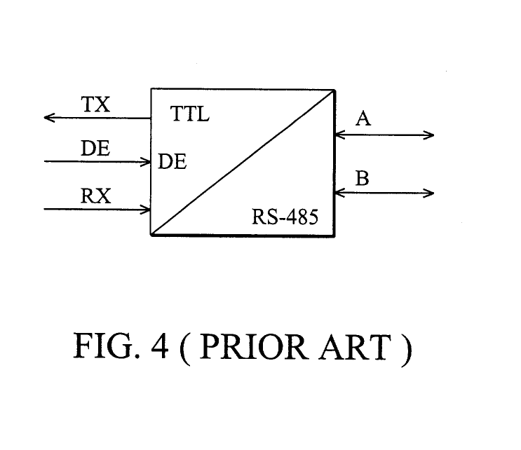

FIG. 4 is a diagram showing an equivalent circuit of the RS485 interface circuit shown in FIG. 3. Data is transferred through lines A and B from the PLC-enabled units to the host when the Rx/Tx control signal remains at a logical low level. On the contrary, data is transferred through lines A and B from the host to the PLC-enabled units when the Rx/Tx control signal rises to a logical high level.

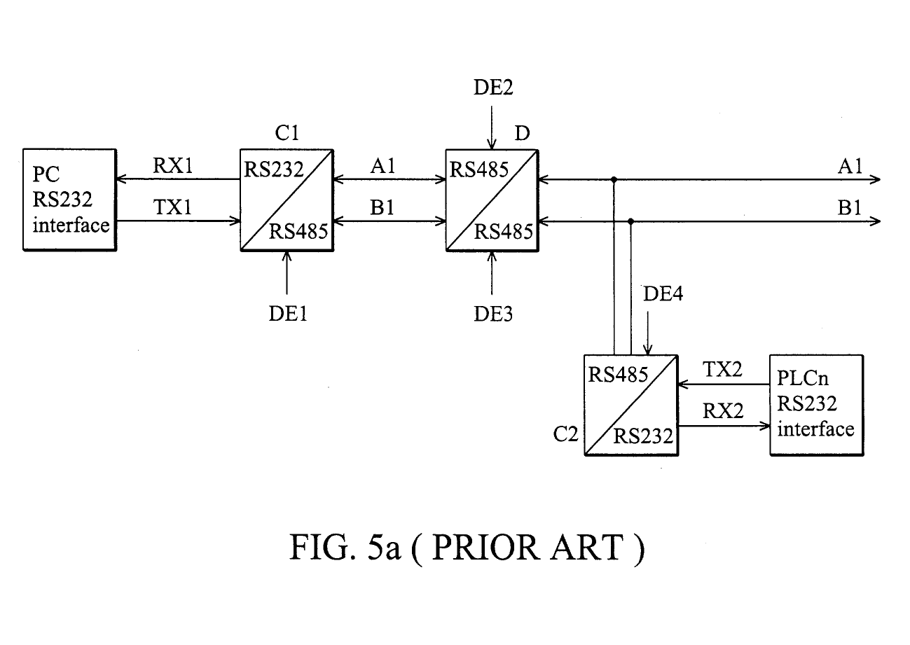

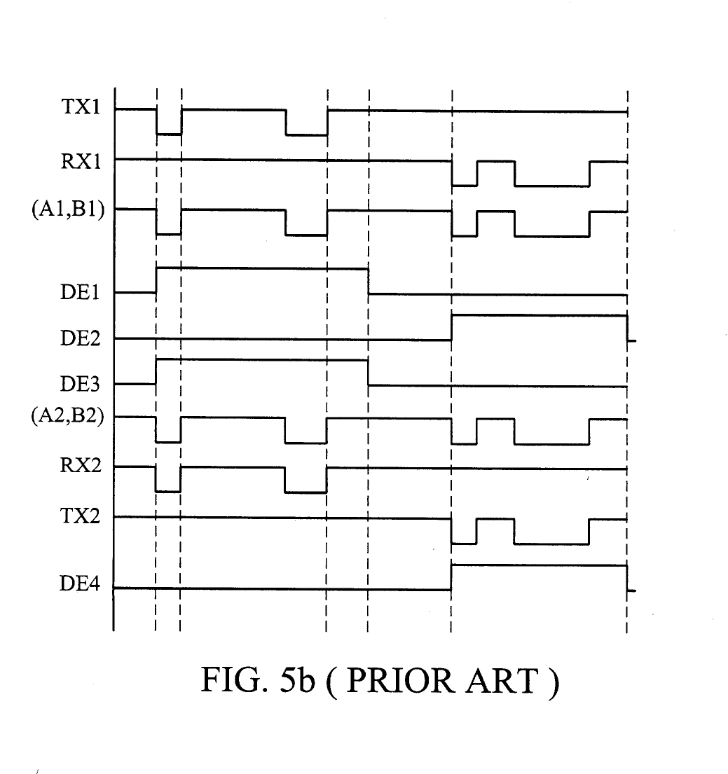

FIG. 5a is a diagram showing a conventional RS232/RS485 network of PLC-enabled units and FIG. 5b is a diagram showing time sequence of the signals according to the network shown in FIG. 5a. It is noted from FIGS. 5a and 5b that, initially, all the Rx/Tx control signals DE1, DE2, DE3 and DE4 remain at the logical low level, and lines A1 and B1 are ready for data transfer from the PLC-enabled units to the host. When the host sends commands through the converter C1 and the signal Tx rises for data transfer, the Rx/Tx control signal also rises and the data is transferred through lines A1 and B1. The Rx/Tx control signal DE2 of the repeater D remains at the logic low level for the repeater D to receive data from lines A1 and B1. The Rx/Tx control signal DE3 then rises so that the data is further transferred to lines A2 and B2. The Rx/Tx control signal DE4 remains at the logical low level for data transfer from lines A2 and B2 to RX2. Finally, the commands sent from the host are transferred to the PLC-enabled unit PLCn.

It can be seen from the previous explanation to the network shown in FIGS. 5a and 5b that the Rx/Tx control signals DE1˜DE4 determine the direction of data transfer and their time sequence is critical to the operation of the network.

When the data (commands) transfer from the host to the PLC-enabled unit PLCn is finished, the Rx/Tx control signals DE1 and DE3 return to the logic low level for responses from the PLC-enabled units. In a situation in which the PLC-enabled units have the same baud rate, 10000 bits/sec for example, and the same byte length, 10 bits for example, the Rx/Tx control signals DE1 and DE3 return to the logic low level 10*1/10000 sec after the command transfer finishes. Thus, a clock is used to determine when the Rx/Tx control signal should go down.

Next, when the PLC-enabled unit PLCn responds to the received commands, the Rx/Tx control signals DE1 and DE3 go down, and DE2 and DE4 already remain at low level. All interface circuits are ready for data transfer from the PLC-enabled units to the host. When the PLC-enabled unit PLCn responds through the line TX2, the Rx/Tx control signal DE4 rises and the response is transferred through lines A2 and B2. The Rx/Tx control signals DE3, DE2, and DE1 are at low, high and low level respectively. Thus, the responses on lines A2 and B2 are transferred through lines A1 and B1 to RX1. Finally, the responses sent from the PLC-enabled unit PLCn are transferred to the host. After the responses are transferred to the host, the Rx/Tx control signals DE2 and DE4 rise.

The commands from the host or the responses from the PLC-enabled unit may be carried by multiple bytes. In such a situation, the PLC-enabled unit does not respond until all the command bytes are received. All the bytes of the commands and responses are sequentially transferred as previously described.

The network configuration shown in FIG. 5a operates properly when all the PLC-enabled units have the same baud rate and byte length. However, as previously described, when the baud rates and byte lengths of the PLC-enabled units are different and the time interval for each byte varies with the PLC-enabled units, the timing of the Rx/Tx control signals DE1˜DE4 will be erroneous. This causes the network to fail.

Accordingly, the present invention provides a gate controller and control method for RS232/485 network, wherein the timing of the Rx/Tx control signals DE1˜DE4 is controllable.

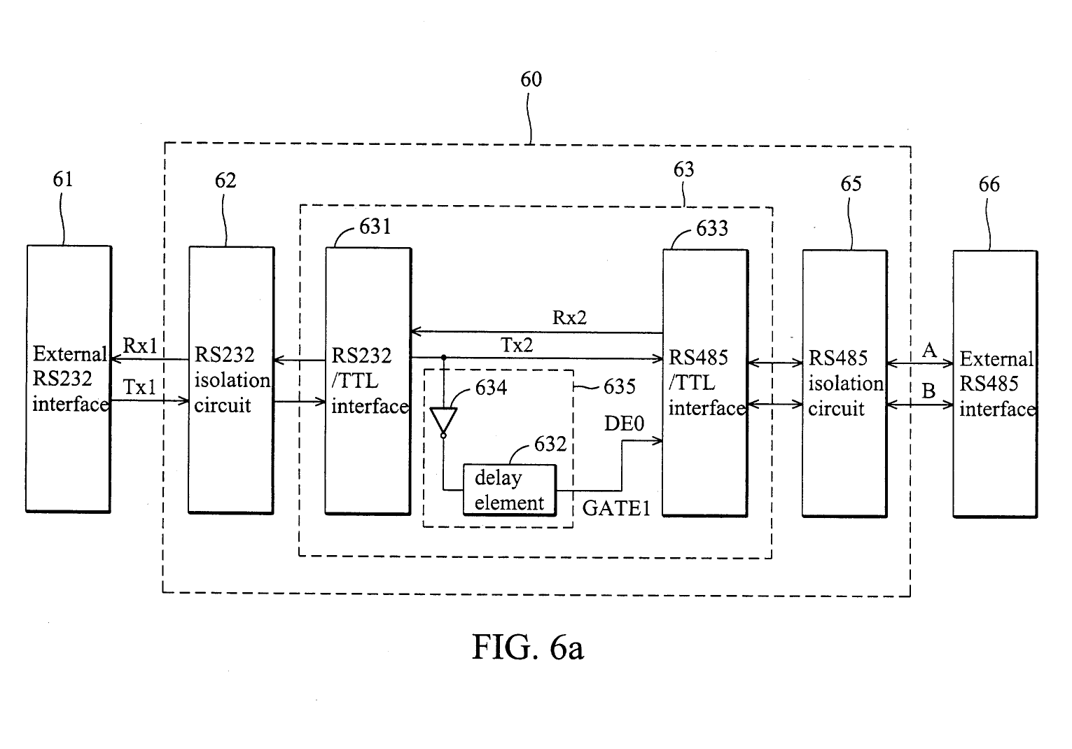

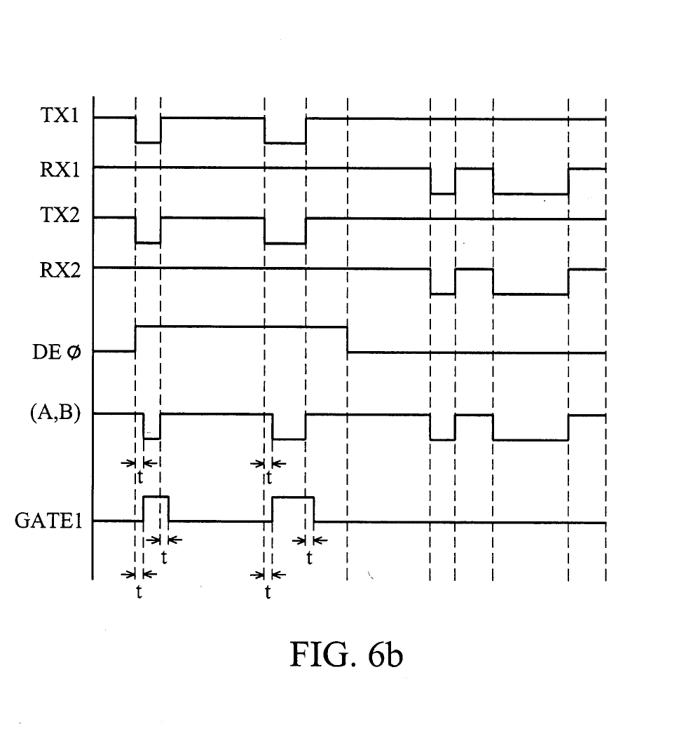

FIG. 6a is a diagram showing a gate controller 63 in a converter 60 according to one embodiment of the invention. It is connected between a RS232 isolated circuit 62 and a RS485 isolated circuit 65. The converter 60 converts the signals between the RS232 interface circuit 61 and RS485 interface circuit 66.

The RS232 isolated circuit 62 is connected between the RS232 interface circuit 61 and RS232/TTL interface circuit 631. The RS485 isolated circuit 65 is connected between the RS485 interface circuit 66 and RS485/TTL interface circuit 633. These isolated circuits protect the gate controller 63 from damage of noise, high voltage pulses, and overload. The isolated circuits and the gate controller may be integrated together.

The gate controller 63 includes a RS232/TTL interface circuit 631, a RS485/TTL interface circuit and a phase processing unit 635. The phase processing unit 635 includes a delay element 632 and an inverter 634.

The signal TX2 from the RS232/TTL interface circuit 631 and the signal TX1 from the RS232 interface circuit 61 are in phase. The signal TX2 is further transferred to the RS485/TTL interface circuit 633, the inverter 634 and the delay element 632. The signal TX2 is inverted and delayed for a time interval t so that a signal GATE1 is input to the Rx/Tx control terminal of the RS485/TTL interface circuit 633 as the Rx/Tx control signal DE0.

Alternatively, the inverter 634 may be connected between the delay element 632 and the RS485/TTL interface circuit 633.

The RS485/TTL interface circuit 633 transforms the signal TX2 into signals A and B input to the RS485 interface circuit 66 when the signal GATE1 is at low level.

FIG. 6b is a diagram showing time sequence of the signals according to the gate controller shown in FIG. 6a. In the conventional network, the signal DE0 goes down for a time interval after the signal TX1 is transferred to the RS485 interface circuit 66 through lines A and B.

Instead, the signal GATE1 is derived by inverting and delaying the signal TX2 rather than using a clock. Initially, the signal GATE1 remains at the logic low level.

The signal GATE1 rises for a period of time t determined by the delay element 632 after the signal TX2 goes down.

On the other hand, the signal GATE1 goes down for the time interval t determined by the delay element 632 after the signal TX2 rises.

The previously described time period t is determined by the delay element 632 according to requirements of the RS485/TTL interface circuit, and independent from the baud rates and byte lengths of the PLC-enabled units. Thus, the network with the converter 60 works despite differences for the baud rates and byte lengths of the PLC-enabled units.

A method for control of a digital asynchronized half-duplex serial transmission gate coupled between a RS232/TTL interface and a RS485/TTL interface having a Rx/Tx control terminal is explained in the following accompanied by FIG. 6a.

A RS232 signal is received and transformed into a TTL signal by the RS232/TTL interface 631.

The TTL signal is inverted and delayed for the time interval t to generate the Rx/Tx control signal GATE1;

The Rx/Tx control signal GATE1 is sent to the Rx/Tx control terminal DE0.

The TTL signal is received and transformed into a RS485 signal by the RS485/TTL interface circuit 633 according to the Rx/Tx control signal GATE1 input to the Rx/Tx control terminal DE0.

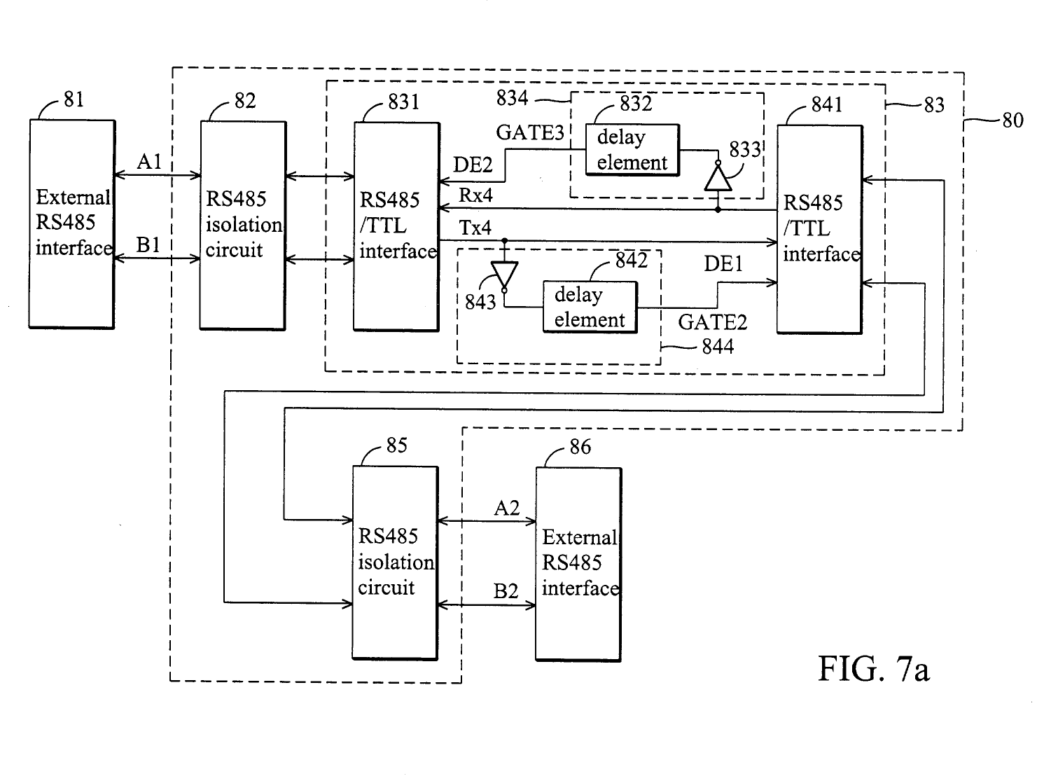

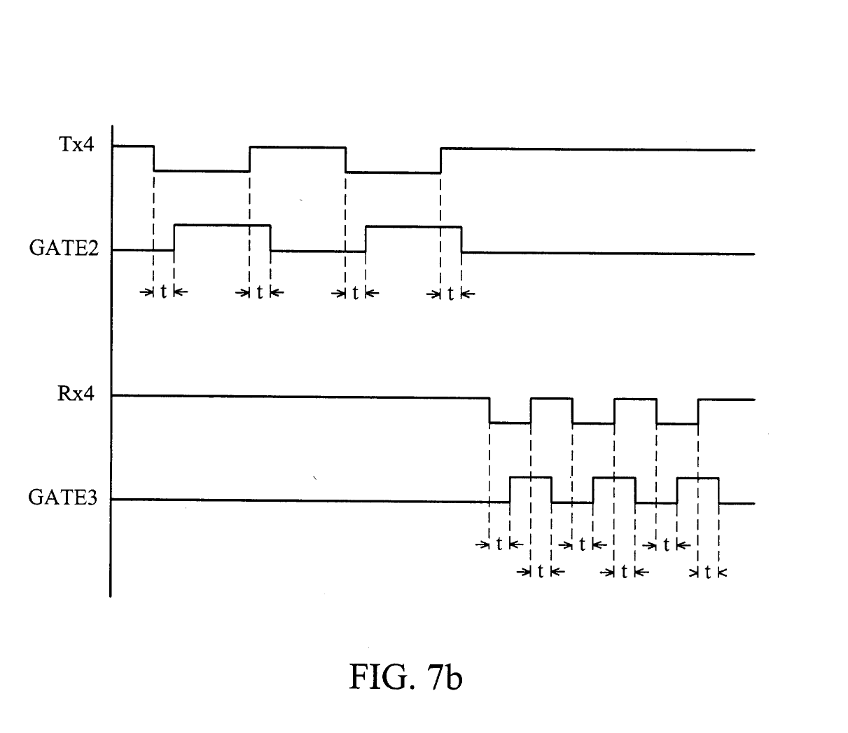

FIG. 7a is a diagram showing a gate controller 83 in a repeater 80 according to another embodiment of the invention. FIG. 7b is a diagram showing time sequence of the signals according to the gate controller 83 shown in FIG. 7a. The gate controller 83 is connected between two RS485 isolated circuits 82 and 85. The repeater 80 repeats the signals between the two RS485 interface circuits 81 and 86.

The gate controller 83 includes a first and second RS485/TTL interface circuit 831 and 841, and a first and second phase processing units 834 and 844. The first phase processing unit 844 includes a first delay element 842 and a first inverter 843. The second phase processing unit 834 includes a second delay element 832 and a second inverter 833.

The RS485 isolated circuit 82 is connected between the RS485 interface circuit 81 and RS485/TTL interface circuit 831. The RS485 isolated circuit 85 is connected between the RS485 interface circuit 841 and RS485/TTL interface circuit 86. These isolated circuits protect the gate controller 83 from damage of noise, high voltage pulses, and overload. The isolated circuits and the gate controller may be integrated together.

The signal TX4 from the RS485/TTL interface circuit 831 is transferred to the RS485/TTL interface circuit 841, the inverter 843 and the delay element 842. The signal TX4 is inverted and delayed for a time interval t so that a signal GATE2 is input to the Rx/Tx control terminal of the RS485/TTL interface circuit 841 as the Rx/Tx control signal DE1. The RS485/TTL interface circuit 841 further transfers the signal TX4 to lines A2 and B2 according to the Rx/Tx control signal DE1.

When the PLC-enabled unit receives commands from the host, it generates responses received by the RS485 interface circuit 86 through lines A2 and B2. The RS485/TTL interface circuit 841 transforms the signals through lines A2 and B2 into the signal RX4 input to the RS485/TTL interface circuit 831. The signal RX4 from the RS485/TTL interface circuit 841 is also transferred to the inverter 833 and the delay element 832. The signal RX4 is inverted and delayed for a time interval t so that a signal GATE3 is input to the Rx/Tx control terminal of the RS485/TTL interface circuit 831 as the Rx/Tx control signal DE2. The RS485/TTL interface circuit 831 further transfers the signal RX4 to lines A1 and B1 according to the Rx/Tx control signal DE2.

Alternatively, the inverter 843 may be connected between the delay element 842 and the RS485/TTL interface circuit 841. The inverter 833 may be connected between the delay element 832 and the RS485/TTL interface circuit 831.

FIG. 7b is a diagram showing time sequence of the signals according to the gate controller shown in FIG. 7a. The signal GATE2 is produced by inverting and delaying the signal TX4. Initially, the signal GATE2 remains at the logic low level.

The signal GATE2 rises for a time interval t determined by the delay element 842 after the signal TX4 goes down.

On the other hand, the signal GATE2 goes down for the time interval t determined by the delay element 842 after the signal TX4 rises.

Similarly, the signal GATE3 initially remains at the logic low level. The signal GATE3 rises for a time interval t determined by the delay element 832 after the signal RX4 goes down.

On the other hand, the signal GATE3 goes down for the same time interval t determined by the delay element 832 after the signal RX4 rises.

The previously described time interval t is determined by the delay elements 832 and 842 according to requirements of the RS485/TTL interface circuits 841 and 831, and independent from the baud rates and byte lengths of the PLC-enabled units. Thus, the network with the repeater 80 works despite differences for the baud rates and byte lengths of the PLC-enabled units.

A method for control of a digital asynchronized half-duplex serial transmission gate coupled between two RS485/TTL interface circuits having Rx/Tx control terminals is explained in the following accompanied with FIG. 7a.

A first RS485 signal is received and transformed into a first TTL signal (TX4) by the RS485/TTL interface 831.

The first TTL signal is inverted and delayed for the time interval t to generate the Rx/Tx control signal GATE2.

The Rx/Tx control signal GATE2 is sent to the Rx/Tx control terminal DE1.

The first TTL signal is received and transformed into a first RS485 signal by the RS485/TTL interface circuit 841 according to the Rx/Tx control signal GATE2 input to the Rx/Tx control terminal DE1.

A second RS485 signal is received and transformed into a second TTL signal (RX4) by the RS485/TTL interface 841.

The second TTL signal is inverted and delayed for the time interval t to generate the Rx/Tx control signal GATE3.

The Rx/Tx control signal GATE3 is sent to the Rx/Tx control terminal DE2.

The second TTL signal is received and transformed into a second RS485 signal by the RS485/TTL interface circuit 831 according to the Rx/Tx control signal GATE3 input to the Rx/Tx control terminal DE2.

In conclusion, the present invention provides a gate controller and control method for digital asynchronized half-duplex serial transmission, comprising the following features:

1. The utilization in aPLC-enabled unit network having different baud rates and byte lengths, such that the most critical problem in applying conventional configuration to a network with multiple baud rates and byte lengths is eliminated.

2. A simple circuit design is provided, such that a proper Rx/Tx control signal is produced by simply adding a phase processing unit between the interface circuits. This also reduces the required circuit area.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the scope to which they are fairly, legally, and equitably entitled.

What is claimed is:

1. A controller for digital asynchronized half-duplex serial transmission gate comprising:
a RS232/TTL interface for transforming a received RS232 signal into a TTL signal;
a RS484/TTL interface for transforming the TTL signal into a RS485 signal, having a Rx/Tx control terminal; and
a phase processing unit for receiving the TTL signal to generate a Rx/Tx control signal input to the Rx/Tx control terminal, wherein the Rx/Tx control signal is derived by inverting and delaying the TTL signal for a time interval.

2. The controller as claimed in claim 1, wherein the phase processing unit comprises a delay element and an inverter.

3. The controller as claimed in claim 1, wherein the TTL signal is delayed by the phase processing unit for the time interval required by the RS485/TTL interface.

4. The controller as claimed in claim 1, further comprising an isolated circuit for isolating noise, and eliminating ESD pulses and overload.

5. A controller for digital asynchronized half-duplex serial transmission gate, comprising:
a first RS485/TTL interface for transformation between a first TTL signal and a first RS485 signal, having a first Rx/Tx control terminal;
a second RS485/TTL interface for transformation between a second TTL signal and a second RS485 signal, having a second Rx/Tx control terminal;
a first phase processing unit for receiving the first TTL signal to generate a first Rx/Tx control signal input to the first Rx/Tx control terminal, wherein the first Rx/Tx control signal is derived by inverting and delaying the first TTL signal for a first time interval; and
a second phase processing unit for receiving the second TTL signal to generate a second Rx/Tx control signal input to the second Rx/Tx control terminal, wherein the second Rx/Tx control signal is derived by inverting and delaying the second TTL signal for a second time interval.

6. The controller as claimed in claim 5, wherein the first phase processing unit comprises a first delay element and a first inverter, and the second phase processing unit comprises a second delay element and a second inverter.

7. The controller as claimed in claim 5, wherein the first TTL signal is delayed by the first phase processing unit for the first time interval required by the first RS485/TTL interface.

8. The controller as claimed in claim 5, wherein the second TTL signal is delayed by the second phase processing unit for the second time interval required by the second RS485/TTL interface.

9. The controller as claimed in claim 5, wherein duration of the first and second time intervals is the same.

10. The controller as claimed in claim 5, further comprising an isolated circuit for isolating noise, and eliminating ESD pulses and overload.

11. A method for control of a digital asynchronized half-duplex serial transmission gate coupled between a RS232/TTL interface and a RS485/TTL interface having a Rx/Tx control terminal, the method comprising:
reception and transformation of a RS232 signal into a TTL signal by the RS232/TTL interface;
inverting and delaying the TTL signal for a time interval to generate a Rx/Tx control signal;
sending the Rx/Tx control signal to the Rx/Tx control terminal; and
reception and transformation of the TTL signal into a RS485 signal by the RS485/TTL interface according to the Rx/Tx control signal input to the Rx/Tx control terminal.

12. A method for control of a digital asynchronized half-duplex serial transmission gate coupled between a first and a second RS485/TTL interface having a second and a first Rx/Tx control terminal respectively, the method comprising the steps of:
implementing the transformation between a first RS485 signal and a first TTL signal by means of the first RS485/TTL interface;
inverting and delaying the first TTL signal for a first time interval to generate a first Rx/Tx control signal;
sending the first Rx/Tx control signal to the first Rx/Tx control terminal;
reception and transformation of the first TTL signal into a second RS485 signal by means of the second RS485/TTL interface according to the first Rx/Tx control signal input to the first Rx/Tx control terminal;
implementing the transformation between a second RS485 signal and a second TTL signal by means of the second RS485/TTL interface;
inverting and delaying the second TTL signal for a second time interval to generate a second Rx/Tx control signal;
sending the second Rx/Tx control signal to the second Rx/Tx control terminal; and
reception and transformation of second TTL signal into the first RS485 signal by means of the second RS485/TTL interface according to the second Rx/Tx control signal input to the second Rx/Tx control terminal.
